(19) United States
(12) Patent Application Publication
(10) Pub. No.: US 2026/0006134 A1
(43) Pub. Date: Jan. 1, 2026

(54) IMAGE PROCESSING APPARATUS, STORAGE MEDIUM, AND METHOD

(71) Applicant: CANON KABUSHIKI KAISHA, Tokyo (JP)

(72) Inventor: TAKUYA USHINOHAMA, Ibaraki (JP)

(21) Appl. No.: 19/247,817

(22) Filed: Jun. 24, 2025

(30) Foreign Application Priority Data
Jun. 28, 2024 (JP) 2024-104686

(51) Int. Cl. H04N 1/00; H04N 1/32

(52) U.S. Cl. CPC H04N 1/00095; H04N 1/32096

(57) ABSTRACT

An image processing apparatus includes at least one memory storing programs, and at least one processor that executes the stored programs, which cause the at least one processor to perform control to acquire image data, perform control to receive, from a chat server which provides a chat service which a user who has logged in to the image processing apparatus uses, information corresponding to user information about the user, perform posting to a post destination of the chat service based on the information, and perform control to transmit the image data. The posting includes posting information for seeking approval to transmit the image data. The image data is transmitted based on a reaction to the posted information for seeking approval having been received.

### BACKGROUND

### Field

Aspects of the present disclosure generally relate to an image processing apparatus, a storage medium, and a method.

### Description of the Related Art

Image processing apparatuses (multifunction peripherals) each having a plurality of functions such as a facsimile (hereinafter referred to as “FAX”) function and a scanner function are currently used, and such an image processing apparatus is capable of performing transmission and reception of FAX with respect to equipment connected the image processing apparatus via a public telephone network and performing transmission and reception of data with respect to, for example, a personal computer (PC) or server connected the image processing apparatus via a network.

Moreover, in order to, at the time of transmitting FAX, prevent, for example, an information leak caused by transmission to a wrong destination, various contrivances such as double-checking a destination may be required.

In a system discussed in Japanese Patent Application Laid-Open No. 2017-118389, the user preliminarily registers an approver associated with a sender of FAX with an image processing apparatus. Moreover, in the system, in response to a FAX transmission instruction being transmitted from a terminal of the sender of FAX to the image processing apparatus, the image processing apparatus transmits an approval request for FAX to the approver associated with the sender.

In the technique discussed in Japanese Patent Application Laid-Open No. 2017-118389, when trying to transmit FAX after getting approval, the user is required to preliminarily register an approver to which to transmit an approval request for transmitting FAX. This is not limited to the case of transmitting FAX, and, in a case where the user transmits data after getting approval, the same issue also occurs.

### SUMMARY

According to an aspect of the present disclosure, an image processing apparatus includes at least one memory storing programs, and at least one processor that executes the stored programs, which cause the at least one processor to perform control to acquire image data, perform control to receive, from a chat server which provides a chat service which a user who has logged in to the image processing apparatus uses, information corresponding to user information about the user, perform posting to a post destination of the chat service based on the information, and perform control to transmit the image data. The posting includes posting information for seeking approval to transmit the image data. The image data is transmitted based on a reaction to the posted information for seeking approval having been received.

Further features of the present disclosure will become apparent from the following description of exemplary embodiments with reference to the attached drawings.

### BRIEF DESCRIPTION OF THE DRAWINGS

FIG. 1 is a diagram illustrating an example of system configuration.

FIG. 2 is a diagram illustrating an example of a configuration of a multifunction peripheral (MFP).

FIG. 3 is a diagram illustrating an example of a configuration of a terminal device.

FIG. 4 is a diagram illustrating an example of a configuration of a chat server.

FIG. 5 is a diagram illustrating an example of user information which is managed by the chat server.

FIG. 6 is a sequence diagram illustrating an example of processing for posting an approval request for facsimile (FAX) transmission to an approver.

FIGS. 7A and 7B are flowcharts illustrating an example of processing for transmitting a FAX approval request to the chat server.

FIGS. 8A and 8B are diagrams illustrating examples of screens for setting an approver for FAX transmission.

FIG. 9 is a diagram illustrating an example of a screen for setting default values of a FAX job.

FIG. 10 is a diagram illustrating an example of a graphical user interface (GUI) of a chat application in in a case where an approval request for FAX transmission has been posted to an approver.

FIG. 11 is a flowchart illustrating an example of processing for posting an approval request while lumping threads together for each transmission destination of FAX.

FIG. 12 is a diagram illustrating an example of a GUI of a chat application in a case where an approval request for FAX transmission has been posted to a channel.

FIG. 13 is a sequence diagram illustrating an example of processing for posting an approval request for FAX transmission to a channel.

### DESCRIPTION OF THE EMBODIMENTS

Various exemplary embodiments, features, and aspects of the disclosure will be described in detail below with reference to the drawings. Furthermore, the following exemplary embodiments should not be construed to limit the present disclosure set forth in claims, and not all of the combinations of features described in the exemplary embodiments are necessarily essential for solutions in the present disclosure.

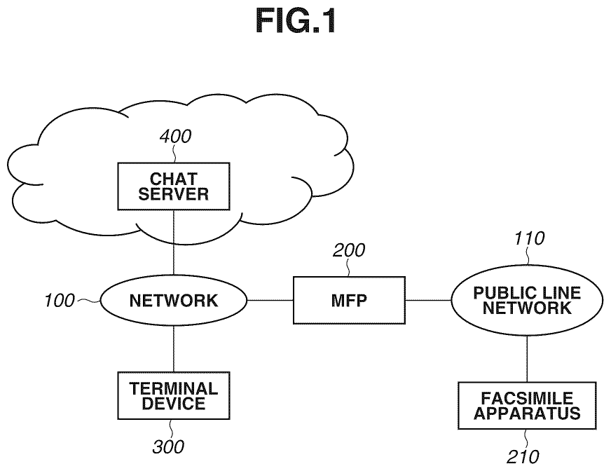

FIG. 1 is a diagram illustrating an example of a system configuration according to a first exemplary embodiment of the present disclosure. In the system configuration according to the first exemplary embodiment, a multifunction peripheral (MFP) 200 and a terminal device 300 are connected to a chat server 400 via a network 100 in such a way as to be able to communicate with the chat server 400.

The network 100 in the first exemplary embodiment can be the Internet or can be a local area network (LAN). Moreover, the network 100 can be a wired network or a wireless network.

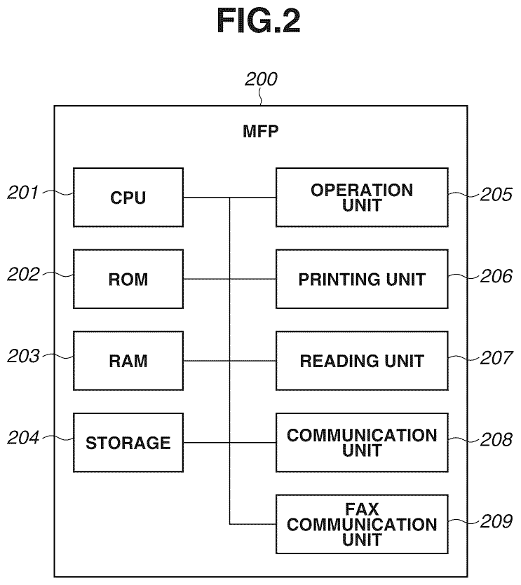

The MFP 200 has the function of transmitting and receiving image data and further has the capability of acquiring image data that is based on an original with use of a reading unit 207 (FIG. 2). The MFP 200 is capable of receiving image data or facsimile (FAX) from, for example, the network 100, such as the Internet, or a public line network 110. Moreover, the MFP 200 in the first exemplary embodiment represents an image processing apparatus which also communicates with the chat server 400 via the network 100 and has the function of performing transmission and reception of image data. Moreover, the MFP 200 is connected to a facsimile apparatus 210 via the public line network 110 and is thus capable of transmitting, by FAX, image data obtained by scanning performed in the MFP 200 to the facsimile apparatus 210 with the telephone number of the facsimile apparatus 210 designated as a transmission destination. Furthermore, the MFP 200 can also have the function of printing an image that is based on the image data on a printing medium. Furthermore, the MFP 200 is able to transmit and receive various pieces of data and various signals. While, in the example illustrated in FIG. 1, a single MFP 200 is connected to the network 100, a plurality of MFPs 200 can be connected to the network 100.

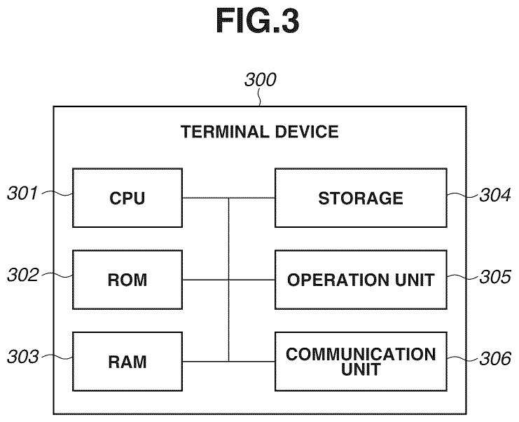

The terminal device 300 is a terminal device which a FAX approver possesses, and is, for example, electronic equipment such as a personal computer (PC), a smartphone, or a tablet PC. The terminal device 300 is able to use a chat service which the chat server 400 provides, so that displaying information about the chat service on an operation unit 305 (FIG. 3) enables the user to use the chat service via the terminal device 300. Specifically, the user can log in to a chat service which the chat server 400 provides via the terminal device 300, thus being able to use the chat service. While, in the example illustrated in FIG. 1, a single terminal device 300 is connected to the network 100, a plurality of terminal devices 300 can be connected to the network 100.

The chat server 400 is a server which provides a chat service, and is a server which manages exchange (chat) of messages between users which use the respective terminal devices 300 connected to the chat server 400 via the network 100. The chat server 400 exchanges pieces of information about the whole processing operations concerning exchange of messages, such as transmission and reception processing of messages and displaying of a display screen for messages, with the terminal device 300. Furthermore, the chat service is a service for enabling users to communicate with each other, and can be, for example, Microsoft Teams®, which Microsoft Corporation provides, or Slack®, which Slack Technologies provides.

FIG. 2 is a diagram illustrating an example of a hardware configuration of the MFP 200. The MFP 200 includes a central processing unit (CPU) 201, a read-only memory (ROM) 202, a random access memory (RAM) 203, a storage 204, an operation unit 205, a printing unit 206, a reading unit 207, a communication unit 208, and a FAX communication unit 209. Furthermore, the respective units included in the MFP 200 are interconnected in such a way as to be able to communicate with each other.

The CPU 201 controls the entire operation of the MFP 200. The CPU 201 reads out control programs stored in the ROM 202 or the storage 204 onto the RAM 203 and thus performs various control operations such as a reading control operation and a printing control operation. The ROM 202 stores control programs which are executable by the CPU 201. The RAM 203 is a main storage memory, and is used as a temporary storage region for loading thereon various control programs stored in the ROM 202 or the storage 204. The storage 204 stores every piece of information such as an address book, image data, print data, various programs, and various pieces of setting information. While, in the first exemplary embodiment, a flash memory is assumed to be used as the storage 204, an auxiliary storage device, such as a solid state drive (SSD) or a hard disk drive (HDD), can also be used. Moreover, an embedded MultiMediaCard (eMMC) can also be used.

Furthermore, while the MFP 200 in the first exemplary embodiment is assumed to be configured in such a manner that one CPU 201 uses one RAM 203 (memory) to perform each processing operation illustrated in a sequence described below, the first exemplary embodiment is not limited to this. For example, a configuration in which a plurality of CPUs, a plurality of RAMs, a plurality of ROMs, and a plurality of storages cooperate with each other to perform each processing operation illustrated in a sequence described below can also be employed. Moreover, a configuration in which a hardware circuit such as an application specific integrated circuit (ASIC) or a field-programmable gate array (FPGA) is used to perform some processing operations can also be employed.

The operation unit 205 is, for example, a display unit, such as a liquid crystal panel or a touch panel, and an input unit, such as buttons or hardware keys. The operation unit 205 displays information to the user and detects inputting from the user. Furthermore, inputting from the user detected by the operation unit 205 is transmitted as an electrical signal to each unit.

The printing unit 206 prints image data (print data) stored in the RAM 203 or the storage 204 on a printing medium (a recording sheet of paper) fed from a sheet feed cassette (not illustrated).

The reading unit 207 reads an image on an original, and the CPU 201 converts the read image into image data such as binary data. The image data generated based on an image read by the reading unit 207 is transmitted to an external device or is printed on a recording sheet of paper. Furthermore, the reading unit 207 can also be configured to include an automatic document feeder (ADF), convey an original set on the automatic document feeder, and then perform reading of the original with use of, for example, a scanner. Moreover, the reading unit 207 can also be configured to perform reading of an original by capturing an image of the original with a camera.

The communication unit 208 is able to connect to the network 100 and transmit and receive every piece of data, such as image data, with respect to an external device on the network 100. Specifically, the communication unit 208 receives print data from the terminal device 300 and transmits data or a signal to the chat server 400. Examples of the method of transmission and reception to be performed by the network 100 can include transmission and reception using an e-mail and file transmission using another protocol (for example, File Transfer Protocol (FTP), Server Message Block (SMB), or Web Distributed Authoring and Versioning (WebDAV)). Additionally, performing access using HyperText Transfer Protocol (HTTP) communication from the terminal device 300 also enables performing transmission and reception of various pieces of data via the network 100.

The FAX communication unit 209 connects to the public line network 110, and transmits and receives FAX to and from the facsimile apparatus 210 connected via the public line network 110. The FAX communication unit 209 is able to control a modem and a network control unit (NCU) for facsimile communication (each not illustrated) to perform, for example, connection to the public line network 110 and control of a facsimile communication protocol.

FIG. 3 is a diagram illustrating an example of a hardware configuration of the terminal device 300. The terminal device 300 includes a CPU 301, a ROM 302, a RAM 303, a storage 304, an operation unit 305, and a communication unit 306. Furthermore, the respective units of the terminal device 300 are interconnected in such a way as to be able to communicate with each other. Furthermore, the configuration illustrated in FIG. 3 is merely an example, and the configuration including all of the respective units of the terminal device 300 is not essential.

The CPU 301 controls the entire operation of the terminal device 300. The CPU 301 reads out control programs stored in the ROM 302 or the storage 304 onto the RAM 303 and thus performs various processing operations to control the operation of the terminal device 300. The ROM 302 stores control programs which are executable by the CPU 301. The RAM 303 is a main storage memory, and is used as a temporary storage region for loading various control programs stored in the ROM 302 or the storage 304.

The storage 304 stores every piece of information such as application data, various programs, image data, and various pieces of setting information. Furthermore, as the storage 304, an auxiliary storage device, such as an SSD, an HDD, or an eMMC, can also be used.

The operation unit 305 is, for example, a display unit, such as a liquid crystal panel or a touch panel, and an input unit, such as buttons or hardware keys. The operation unit 305 displays information to the user and detects inputting from the user. Furthermore, inputting from the user detected by the operation unit 305 is transmitted as an electrical signal to each unit.

The communication unit 306 is able to connect to the network 100 and transmit and receive every piece of data, such as image data, with respect to an external device on the network 100. For example, the communication unit 306 performs transmission and reception of image data or data related to a chat service with respect to the chat server 400.

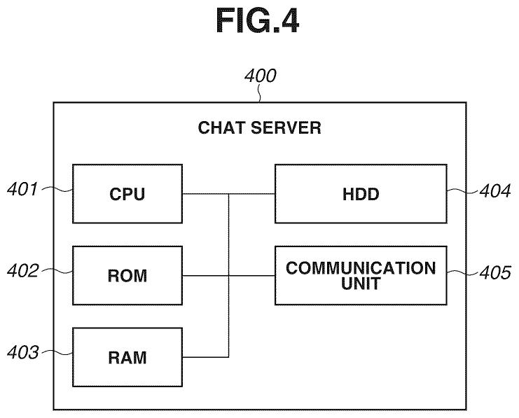

FIG. 4 is a diagram illustrating an example of a hardware configuration of the chat server 400. The chat server 400 includes a CPU 401, a ROM 402, a RAM 403, an HDD 404, and a communication unit 405. Furthermore, the respective units of the chat server 400 are interconnected in such a way as to be able to communicate with each other.

The CPU 401 reads out control programs stored in the ROM 402 or the HDD 404 and thus performs various processing operations to control an operation for the chat service which the chat server 400 provides. The ROM 402 stores control programs. The RAM 403 is used as a main memory and a temporary storage region, such as a work area, for the CPU 401.

The HDD 404 stores various pieces of data such as chat messages and user information about users who use the chat service. The communication unit 405 is able to connect to the network 100 and perform transmission and reception of every piece of data with respect to external equipment such as the MFP 200 or the terminal device 300 on the network 100. Furthermore, the communication unit 405 can be configured to preform wired communication using, for example, Ethernet, or can be configured to perform wireless communication such as Wi-Fi.

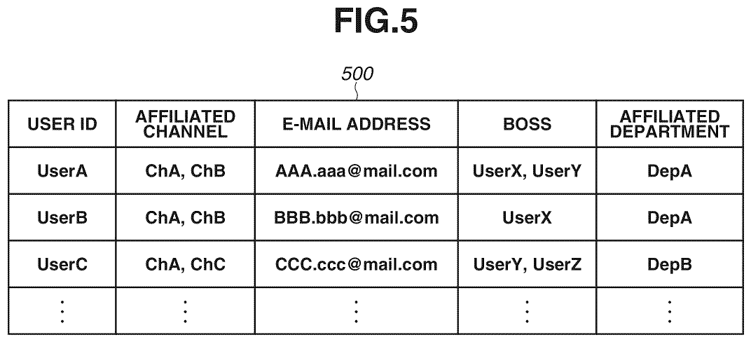

FIG. 5 illustrates an example of a user information list 500 which is stored in the HDD 404 of the chat server 400. In the user information list 500, various pieces of information about users who are currently registered with the chat service which is provided by the chat server 400 are stored in such a way as to be associated with each other. Specifically, with respect to each user, pieces of information about a user identification (ID), affiliated channels on the chat service in which the user participates, an e-mail address serving as a destination to which to send electronic data to the user individual, a user ID of another user who is a boss of the user, and an affiliated department of the user are stored in such a way as to be associated with each other. Besides, for example, token information and passwords are also stored in the user information list 500 in such a way as to be associated with each other. Furthermore, the pieces of information which are stored in the user information list 500 are not limited to the above-mentioned ones, and, for example, pieces of information about an affiliated department of the user, a telephone number of the user, an affiliated channel of another user who is a boss of the user, and advanced settings of the chat service can be stored in such a way as to be associated with each other. Moreover, information about the affiliated channel or information about the affiliated department can be stored as, for example, an identifiable ID. Furthermore, another user who is a boss of the user is a user (approver) who approves FAX transmission. The user ID is a unique name for identifying an individual on the chat, and is used to designate a destination to which to post a chat or indicate a user who has performed posting to the chat. Furthermore, the user information is information which is to be preliminarily registered to use a chat service, and does not need to include all of the above-mentioned items.

Furthermore, in the first exemplary embodiment, the channel is a space in which a plurality of users is able to perform interaction with each other, and is a space in which exchange of, for example, messages, files, and tools is possible. While, in the description of the first exemplary embodiment, a plurality of users is participating in a channel, the first exemplary embodiment is not limited to this.

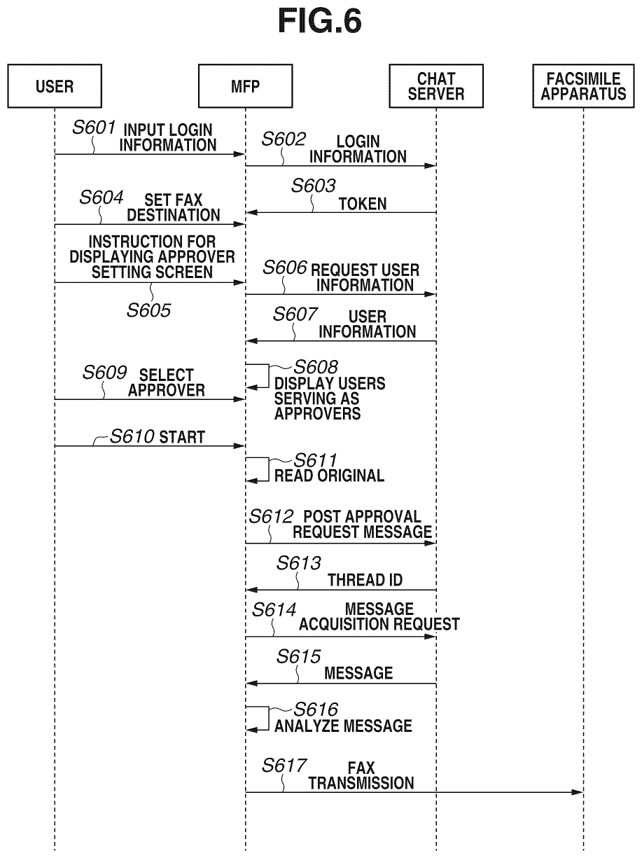

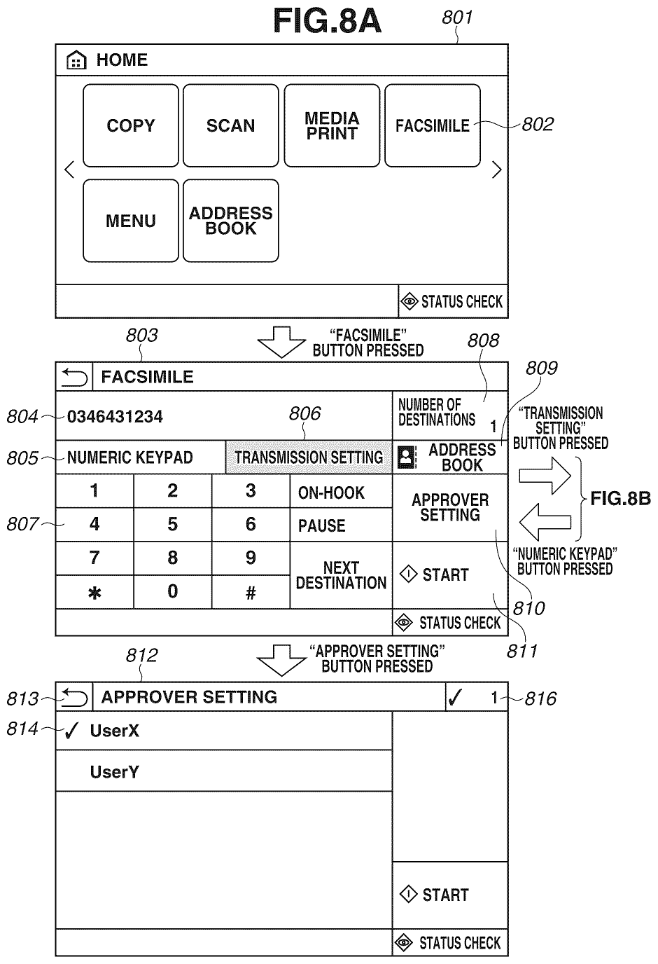

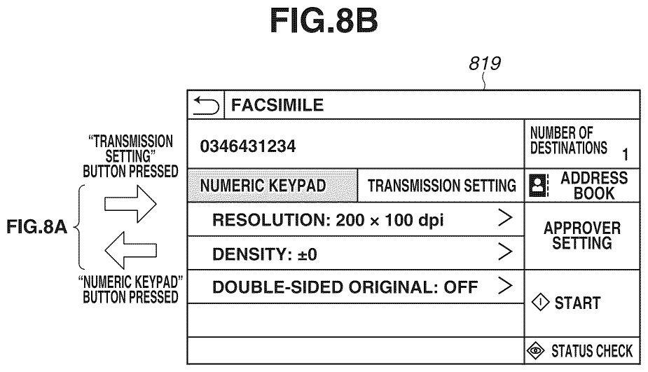

FIG. 6 is a sequence diagram illustrating an example of processing for posting an approval request for FAX transmission to an approver when the MFP 200 performs FAX transmission. The sequence of processing illustrated in FIG. 6 is started in response to a facsimile button 802, which is displayed in a home screen 801 illustrated in FIG. 8A described below, having been selected.

In step S601, the user inputs, to the operation unit 205 of the MFP 200, a user ID and a password for logging in to a chat service which the chat server 400 provides, and the CPU 201 accepts such inputs. In an information acquisition request which is made to the chat server 400 in the subsequent steps, token information which has been acquired by the CPU 201 controlling the communication unit 208 to transmit the user ID and the password input in step S601 to the chat server 400 is assumed to be used. Furthermore, instead of the token information, the user ID and the password input by the user in step S601 can be directly used for authentication. Moreover, login information for the MFP 200 and login information for a chat service which the chat server 400 provides can be preliminarily stored in the storage 204. In that case, the login information preliminarily stored in the MFP 200 is used as login information to be input by the user in step S601, and, in that case, without the user inputting login information for the chat server 400, the processing proceeds to step S602. Furthermore, the login information for the chat service means a user ID and a password or means token information.

In step S602, the CPU 201 of the MFP 200 controls the communication unit 208 to transmit the login information and the password input in step S601 to the chat server 400, and the chat server 400 receives the transmitted login information and password.

In step S603, the CPU 401 of the chat server 400 performs authentication based on the login information and password received in step S602. In response to the authentication being successful, the CPU 401 issues token information, which becomes required for, for example, an information acquisition request to the chat server 400, and controls the communication unit 405 to transmit the token information to the MFP 200. The MFP 200 receives the transmitted token information.

In step S604, the user inputs, to the operation unit 205 of the MFP 200, a telephone number of the facsimile apparatus 210 to be designated as a FAX transmission destination, and the CPU 201 of the MFP 200 accepts the input telephone number.

In step S605, in response to the user pressing an approver setting button 810 to cause an approver setting screen 812 for setting a FAX approver to be displayed, the CPU 201 of the MFP 200 accepts this pressing as an instruction for displaying the approver setting screen 812.

In step S606, the CPU 201 of the MFP 200 controls the communication unit 208 to transmit, to the chat server 400, an instruction for requesting user information by HTTP communication, and the chat server 400 receives the transmitted instruction. Specifically, the CPU 201 controls the communication unit 208 to transmit, to the chat server 400, an instruction for requesting information about a user with whom the user is able to perform chatting indicated by the token information acquired in step S603. Furthermore, as a user information request, the CPU 201 can transmit a request for acquiring information about all of the users with whom the user who, in step S601, has logged in is able to perform chatting, or can transmit a request for acquiring user information corresponding to a user designated by the user who, in step S601, has logged in.

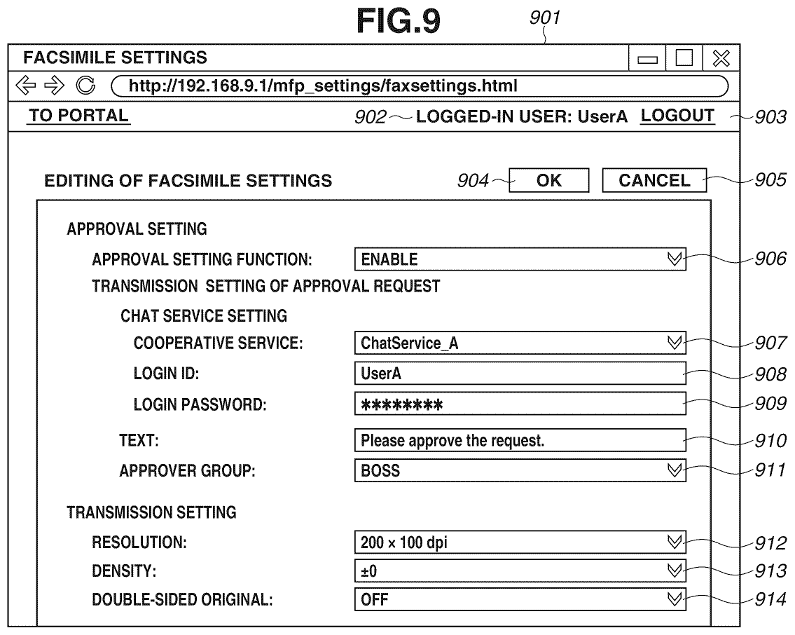

Furthermore, all of the users with whom the user who, in step S601, has logged in is able to perform chatting mean users corresponding to different pieces of user information stored in the HDD 404 of the chat server 400 in association with user information about the user who has logged in the chat service. The user designated by the user who, in step S601, has logged in can be, for example, a user designated by preliminarily designating a condition in such a way as to, for example, narrow designated users down to only a boss in an approver group field 911 of a button setting screen illustrated in FIG. 9. In a case where a setting is currently set by the user in such a way as to narrow designated users down to only a boss, the CPU 201 controls the communication unit 208 to transmit, to the chat server 400, a request indicating acquiring information about a user who is currently registered as a boss of the user who, in step S601, has logged in.

In step S607, the CPU 401 of the chat server 400 checks whether the logged-in user is a user who has been allowed to access the chat service, based on the token information attached to the user information request received in step S606 and the user information list 500. In a case where the logged-in user is a user who has been allowed to access the chat service, according to the user information request, the CPU 401 of the chat server 400 searches for users with whom the user indicated by the token information is able to perform chatting based on the user information list 500. Furthermore, in a case where the request received in step S606 is directed to all of the users with whom the user indicated by the token information is able to perform chatting, the CPU 401 searches for all of the users, and, in a case where the request received in step S606 is directed to a user designated by the logged-in user, the CPU 401 searches for the designated user. The CPU 401 controls the communication unit 405 to transmit, to the MFP 200, user information about the user or users found by searching as response information in HTTP communication. The MFP 200 receives the transmitted user information.

In step S608, based on the user information received in step S607, the CPU 201 of the MFP 200 causes the approver setting screen 812 to be displayed on the operation unit 205, and thus waits for the user to perform an operation thereon. The approver setting screen 812 is described below with reference to FIG. 8A.

In step S609, the user selects a user (approver) as an approver in the approver setting screen 812 displayed on the operation unit 205, and the CPU 201 of the MFP 200 then accepts selection of the approver and thus determines a user to whom to transmit an approval request.

In step S610, the user presses a start button 811, and the CPU 201 of the MFP 200 then accepts a start instruction for FAX transmission via the operation unit 205.

In step S611, the CPU 201 of the MFP 200 controls the reading unit 207 to scan an original, thus generating image data. Furthermore, the user is assumed to, before execution of step S611, have completed placing of an original on the reading unit 207 and general settings which are used for FAX transmission. The general settings include, for example, destination setting, density setting, image quality mode setting, and scan mode setting.

In step S612, the CPU 201 of the MFP 200 controls the communication unit 208 to transmit, to the chat server 400, information for issuing an instruction for posting an approval request message to the approver selected by the user in step S609. Thus, the CPU 201 posts an approval request message to the approver selected by the user in step S609. The approval request message includes a message indicating requesting an approval of FAX transmission, a telephone number of the facsimile apparatus 210 serving as a transmission destination input in step S604, and image data generated in step S611. Furthermore, the approval request message does not necessarily need to include image data generated in step S611. Furthermore, the approval request message is an example of information for seeking approval for transmitting image data.

In step S613, the CPU 401 of the chat server 400 posts the message received in step S612 to a chat room of the chat service. Furthermore, the chat room to which the message is posted is a chat room corresponding to user information about the approver selected by the user in step S609. The CPU 401 controls the communication unit 405 to transmit, to the MFP 200, a thread ID of the thread to which the message has been posted, and the MFP 200 receives the transmitted thread ID.

In step S614, the CPU 201 of the MFP 200 controls the communication unit 208 to check an approval status of the approval request posted in step S612. Specifically, the CPU 201 controls the communication unit 208 to transmit, to the chat server 400, a message acquisition request issuing an instruction for acquiring a message posted to the thread corresponding to the thread ID received in step S613 and the thread ID. The chat server 400 receives the transmitted message acquisition request and thread ID. Furthermore, this processing operation can be performed by the CPU 201 a plurality of times. For example, this processing operation can be repeated until a message is posted to a thread to which the CPU 401 has performed posting in step S612. Besides, a processing operation in the present step can be performed each time a predetermined time elapses, or can be performed a predetermined number of times.

In step S615, the CPU 401 of the chat server 400 checks whether there is a message (reaction) which has been posted to a thread indicated by the thread ID attached to the message acquisition request received in step S614. In a case where there is a message which has been posted to a thread indicated by the received thread ID, the CPU 401 controls the communication unit 405 to transmit, to the MFP 200, a message posted to the thread indicated by the received thread ID. The MFP 200 receives the transmitted message.

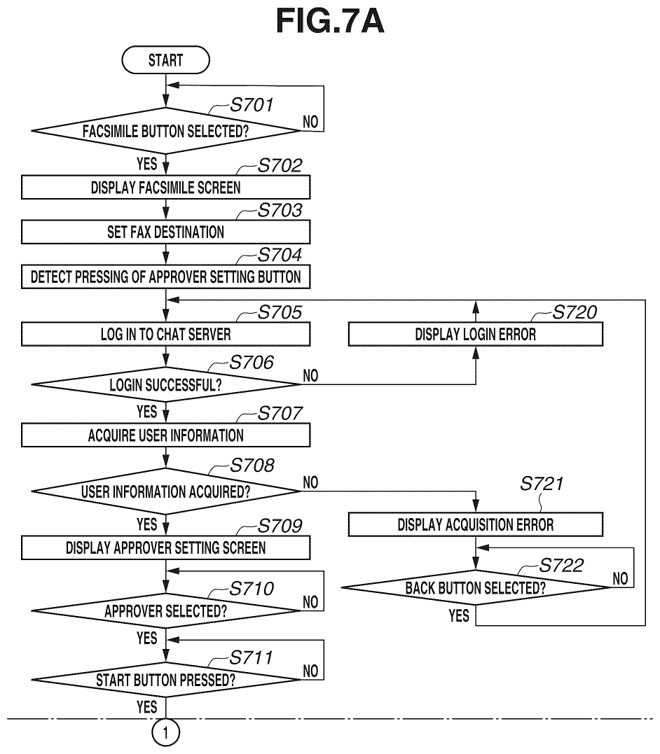

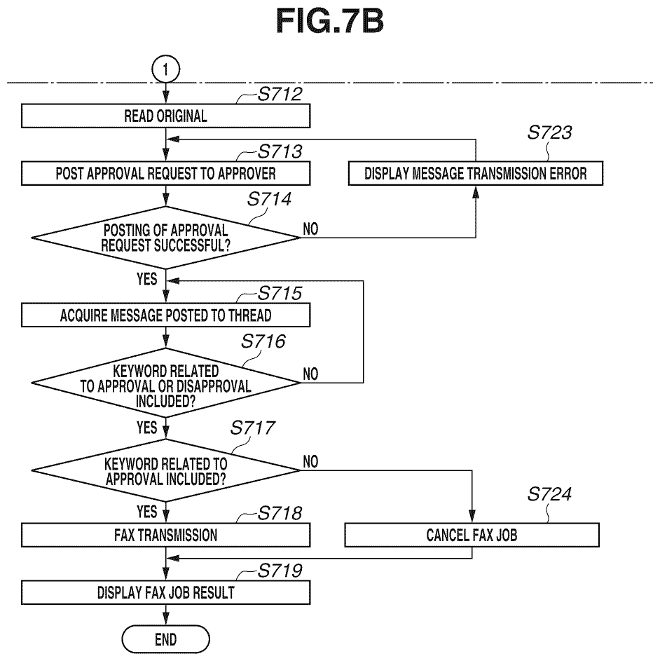

In step S616, the CPU 201 of the MFP 200 analyzes the message received in step S615 and determines whether the received message is a message indicating approving FAX transmission. The determination as to whether the received message is a message indicating approving FAX transmission is described below with reference to FIGS. 7A and 7B.

In step S617, the CPU 201 of the MFP 200 controls the FAX communication unit 209 to perform FAX transmission of the image data obtained by scanning in step S611 to the facsimile apparatus 210 corresponding to the telephone number which the user has input in step S604. Furthermore, this processing operation is performed in a case where it is determined that the message received in step S616 is a message indicating approving FAX transmission, and is not performed in a case where it is determined that the received message is not a message indicating approving FAX transmission.

FIGS. 7A and 7B are flowcharts illustrating an example of processing for posting an approval request for FAX transmission to an approver when the MFP 200 performs FAX transmission. The processing in the present flowchart is implemented by the CPU 201 of the MFP 200 reading out a program stored in the ROM 202 onto the RAM 203 and executing the program. Moreover, the processing in the flowcharts of FIGS. 7A and 7B is started in response to the MFP 200 being powered on.

In step S701, the CPU 201 determines whether the facsimile button 802 has been selected by the user. If it is determined that the facsimile button 802 has been selected (YES in step S701), the CPU 201 advances the processing to step S702. If not so (NO in step S701), the CPU 201 waits until it is determined that the facsimile button 802 has been selected.

In step S702, the CPU 201 causes a facsimile screen 803 to be displayed on the operation unit 205.

In step S703, the user inputs a destination serving as a FAX transmission destination in the facsimile screen 803, and, upon detecting that a destination has been input, the CPU 201 causes destination information to be displayed in a destination display field 804. The setting of a destination can be performed by, for example, a telephone number being input with a numeric keypad 807 which is displayed in the facsimile screen 803, or can be performed by a destination being selected from an address book which is displayed in response to an address book button 809 being selected.

In step S704, the CPU 201 detects that the approver setting button 810, which is provided for causing the approver setting screen 812 for selecting an approver for FAX transmission by the user to be displayed, is selected.

In step S705, the CPU 201 logs in to a chat service which the chat server 400 provides, with use of login information for the chat service preliminarily stored in the MFP 200. Specifically, the CPU 201 controls the communication unit 208 to transmit login information for the chat service to the chat server 400. The chat server 400, which has received the login information, performs authentication based on the login information transmitted from the CPU 201, and, upon successful authentication, the CPU 201 becomes able to log in to the chat service. Furthermore, the CPU 401 of the chat server 400 performs this authentication based on the user information list 500. Upon successful authentication in the chat server 400, the CPU 201 receives token information which is transmitted from the chat server 400. Furthermore, in a case where login information is not preliminarily stored in the MFP 200, in step S705, the CPU 201 causes a login screen to be displayed on the operation unit 205, and logs in to the chat server 400 with use of a user ID and a password which have been input by the user.

In step S706, the CPU 201 determines whether the login to the chat service is successful. Specifically, in a case where the CPU 201 has received token information from the chat server 400 with respect to the login information transmitted in step S705, the CPU 201 determines that the login is successful. On the other hand, in a case where a status code included in a response in HTTP communication is an error or in a case where a parameter indicating that information is unable to be acquired is included in body information included in the response, the CPU 201 determines that the login is not successful. If it is determined that the login is successful (YES in step S706), the CPU 201 advances the processing to step S707, and, if not so (NO in step S706), the CPU 201 advances the processing to step S720.

In step S720, the CPU 201 causes the facsimile screen 803 to be displayed on the operation unit 205, causes information indicating that the login to the chat service is unsuccessful to be displayed in the facsimile screen 803, and then returns the processing to step S705.

In step S707, the CPU 201 controls the communication unit 208 to transmit, to the chat server 400, information indicating requesting user information in HTTP communication with use of the token information received in step S705. At this time, according to the user information request, the chat server 400 searches for a user with whom the user indicated by the token information is able to chat, and transmits user information about the applicable user found by searching to the MFP 200. The MFP 200 receives the transmitted user information. At this time, the CPU 401 of the chat server 400 performs searching based on the user information list 500.

Furthermore, in a case where an approver is currently designated by a user, the chat server 400 transmits, to the MFP 200, user information corresponding to the designated approver. Accordingly, in the present step, the MFP 200 receives the user information transmitted from the chat server 400.

Furthermore, all of the users with whom the user indicated by the token information is able to chat mean users corresponding to different pieces of user information stored in the HDD 404 of the chat server 400 in association with user information about the user who has logged in the chat service.

In step S708, the CPU 201 determines whether the user information has been received from the chat server 400 with respect to the user information request transmitted in step S707. Specifically, in a case where the CPU 201 has received user information from the chat server 400, the CPU 201 determines that the user information has been received. On the other hand, in a case where a status code included in a response in HTTP communication is an error or in a case where a parameter indicating that user information is unable to be acquired is included in body information included in the response, the CPU 201 determines that the user information has not been received. If it is determined that the user information has been received (YES in step S708), the CPU 201 advances the processing to step S709, and, if not so (NO in step S708), the CPU 201 advances the processing to step S721.

In step S721, the CPU 201 causes the approver setting screen 812 to be displayed on the operation unit 205 and causes information indicating that the user information has not been received to be displayed in the approver setting screen 812. At this time, options for a user serving as an approver are not displayed in the approver setting screen 812.

In step S722, the CPU 201 determines whether a back button 813 has been selected. If it is determined that the back button 813 has been selected (YES in step S722), the CPU 201 returns the processing to step S705, and, if not so (NO in step S722), the CPU 201 waits until it is determined that the back button 813 has been selected.

In step S709, the CPU 201 causes a user list 814, which is based on the user information received from the chat server 400, to be displayed in the approver setting screen 812 displayed on the operation unit 205, waits for the user's selection, and, in a case where a selection operation has been performed, detects the selection operation and accepts the selection. Thus, the CPU 201 accepts a post destination to which to post an approval request message.

In step S710, the CPU 201 determines whether a user serving as an approver has been selected by the user in the approver setting screen 812. If it is determined that a user serving as an approver has been selected (YES in step S710), the CPU 201 advances the processing to step S711, and, if not so (NO in step S710), the CPU 201 waits until a user serving as an approver is selected.

The detection of selection is performed based on which of users included in the user list 814 displayed in the approver setting screen 812 has been selected. Furthermore, in the case of a screen configuration in which a confirm button is displayed in the screen of the operation unit 205, if the confirm button is pressed in a state in which a user included in the user list 814 has been selected, a similar transition in steps is also performed.

In step S711, the CPU 201 determines whether the start button 811 displayed on the operation unit 205 has been selected. If it is determined that the start button 811 has been selected (YES in step S711), the CPU 201 advances the processing to step S712, and, if not so (NO in step S711), the CPU 201 waits until the start button 811 is selected. Furthermore, such a start button is not limited to the start button 811 displayed in the facsimile screen 803, but can be, for example, a start button displayed in the approver setting screen 812 or can be a hardware key included in the operation unit 205.

In step S712, the CPU 201 controls the reading unit 207 to read an original, thus generating image data. Furthermore, the user is assumed to, before execution of step S712, have completed placing of an original on the reading unit 207 and general FAX settings. The general FAX settings include, for example, destination setting, density setting, image quality mode setting, and scan mode setting. Furthermore, image data which has been stored in the storage 204 can also be used, and, in that case, the present step becomes unnecessary.

In step S713, the CPU 201 transmits, to the chat server 400, a message post request to issue an instruction for posting an approval request message to the user selected by the user in step S710. The approval request message includes a message indicating requesting an approval of FAX transmission, the destination information input in step S703, and the image data generated in step S712.

Furthermore, the approval request message does not necessarily need to include image data generated in step S712. At this time, if the chat server 400 succeeds in posting the message, the CPU 201 receives information indicating a result of posting of the message transmitted from the chat server 400. Specifically, if the chat server 400 succeeds in posting the message, the CPU 201 receives information indicating a success of posting of the message.

Furthermore, while, in the present processing operation, one thread is assumed to be created with respect to one FAX job, in a case where a thread to which posting related to approval of FAX transmission to the same destination as the destination input in step S703 has been performed already exists, a message can also be posted additionally to the already-existing thread.

In step S714, the CPU 201 determines whether, with respect to the message post request transmitted in step S713, information indicating the success of posting of the message has been received from the chat server 400. Specifically, in a case where the CPU 201 has received a thread ID of the thread to which the message has been posted or in a case where a status code included in a response in HTTP communication is a status indicating success, the CPU 201 determines that posting of the message is successful. On the other hand, in a case where the received status code is an error or in a case where a parameter indicating that posting of the message is failed is included in body information included in the response, the CPU 201 determines that posting of the message is failed. If it is determined that posting of the message is successful (YES in step S714), the CPU 201 advances the processing to step S715, and, if not so (NO in step S714), the CPU 201 advances the processing to step S723.

In step S723, the CPU 201 causes the facsimile screen 803 to be displayed on the operation unit 205, causes information indicating that an approval request message has not been able to be posted to the designated approver to be displayed, and then returns the processing to step S713.

In step S715, the CPU 201 controls the communication unit 208 to transmit, to the chat server 400, information indicating requesting a message posted to the thread to which posting has been performed in HTTP communication, with use of the thread ID received in step S714. Furthermore, the CPU 201 can transmit, to the chat server 400, information indicating requesting only a message which the user account of the approver has posted from among messages posted to the chat room in HTTP communication, with use of the token information received in step S706.

At this time, according to a request from the CPU 201 of the MFP 200, the CPU 401 of the chat server 400 controls the communication unit 405 to transmit the applicable message to the MFP 200.

The MFP 200 receives the transmitted message.

In step S716, the CPU 201 determines whether a keyword related to approval or disapproval of FAX transmission is included in the message received in step S715. The keyword related to approval is, for example, a character string such as “I approve.”, “No problem.”, or “OK!”, the keyword related to disapproval is, for example, a character string such as “I disapprove.”, “There is a problem.”, or “NG!”, and the keyword is preliminarily set by the user. Furthermore, these examples are examples of a character string indicating approval and a character string indicating disapproval. These keywords related to approval or disapproval are stored in, for example, the storage 204 of the MFP 200. Based on the keywords set by the user, the CPU 201 determines whether a keyword related to approval or disapproval of FAX transmission is included in the message received in step S715. If it is determined that a keyword related to approval or disapproval is included in the message (YES in step S716), the CPU 201 advances the processing to step S717, and, if not so (NO in step S716), the CPU 201 returns the processing to step S715.

In step S717, the CPU 201 determines whether a keyword related to approval is included in the message received in step S715. With regard to this determination, as with step S716, based on the keywords set by the user, the CPU 201 determines whether a keyword related to approval of FAX transmission is included in the message. Here, in a case where it is determined in step S716, which is a preceding step, that a keyword related to approval or disapproval is included in the message and no keyword related to approval is included in the message, it is apparent that a keyword related to disapproval is included in the message. Thus, in a case where a keyword related to disapproval is included in the message, in the present step, the CPU 201 determines that no keyword related to approval is included in the message. If it is determined that a keyword related to approval is included in the message (YES in step S717), the CPU 201 advances the processing to step S718, and, if it is determined that no keyword related to approval is included in the message (NO in step S717), the CPU 201 advances the processing to step S724.

In step S724, the CPU 201 cancels FAX transmission and deletes a FAX job.

In step S718, the CPU 201 controls the FAX communication unit 209 to perform FAX transmission of image data generated by reading an original in step S712 to the facsimile apparatus 210 corresponding to the telephone number input by the user in step S703 via the public line network 110.

In step S719, the CPU 201 causes a FAX transmission result to be displayed on the operation unit 205. At this time, the CPU 201 transmits, to the chat server 400, a message post request issuing an instruction for posting a message related to a FAX transmission result obtained in step S718 or step S724. The content of the message to be posted includes, for example, “FAX transmission is successful.” or “FAX transmission is failed.”.

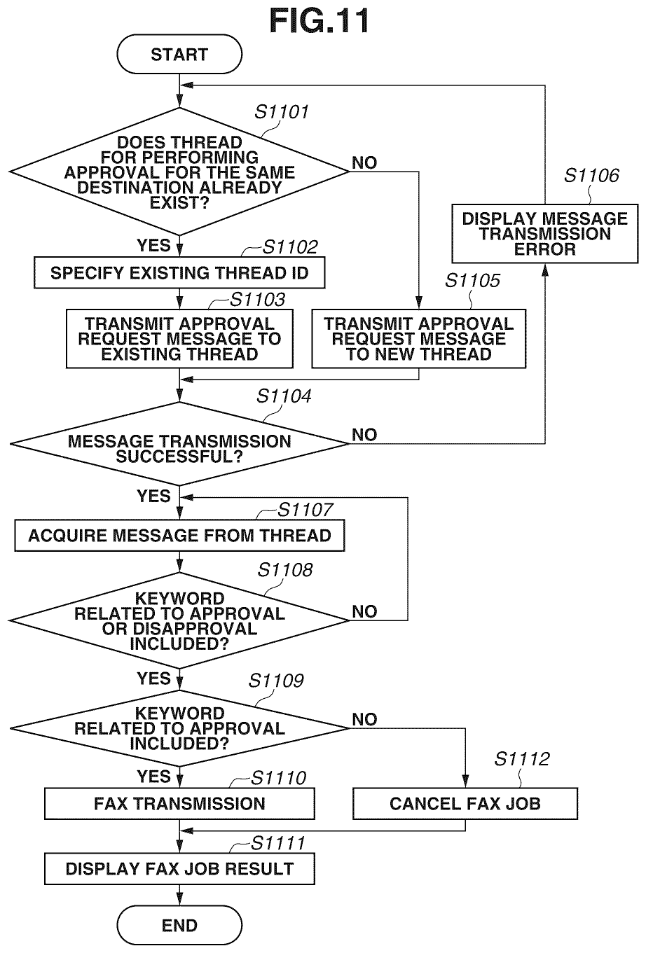

FIG. 11 is a flowchart illustrating an example of processing which is performed in the case of lumping approval threads together with respect to each transmission destination of FAX. The processing in the present flowchart is implemented by the CPU 201 of the MFP 200 reading out a program stored in the ROM 202 onto the RAM 203 and executing the program. Moreover, the processing in the flowchart of FIG. 11 is started in response to a processing operation in step S712 illustrated in FIG. 7B ending. Thus, the present processing is processing which is performed at the second and subsequent times in the case of transmitting FAX to the same destination two or more times.

In step S1101, the CPU 201 determines whether a thread for performing approval of FAX to be transmitted to a FAX transmission destination input by the user in step S703 already exists. Thus, the CPU 201 determines whether a thread for requesting approval with respect to the same FAX transmission destination already exists. Specifically, the CPU 201 acquires, from the chat server 400, thread information about a post destination received in step S709, and determines whether an approval request to the same destination as the destination input in step S703 is included in a message of each thread. Furthermore, the thread information includes, in addition to a thread ID, the content of a message constituting the thread, and, at least, the thread ID and the message content are associated with each other. Furthermore, the determination can be performed by another method, and the CPU 201 can preliminarily store the thread ID received in step S715 based on the post request transmitted in step S713 and the destination in the storage 204 while associating them with each other and perform the above-mentioned determination based on whether a thread ID associated with the destination of FAX transmission is currently stored.

If it is determined that a thread for requesting approval with respect to the same FAX transmission destination already exists (YES in step S1101), the CPU 201 advances the processing to step S1102, and, on the other hand, if it is determined that no thread for requesting approval with respect to the same FAX transmission destination exists (NO in step S1101), the CPU 201 advances the processing to step S1105.

In step S1102, the CPU 201 identifies a thread ID of the thread for requesting approval with respect to the same destination acquired in step S1101. Specifically, the CPU 201 compares the destination of FAX transmission input in step S703 with the thread information acquired in step S1101, searches for messages including the same telephone number, and identifies a thread ID associated with the applicable messages.

In step S1103, the CPU 201 controls the communication unit 208 to transmit, to the chat server 400, a message replay request issuing an instruction for sending, as a reply, a message to a thread of the thread ID identified in step S1102, with use of the token information acquired in step S705. The message replay request, as with the message reply request to be transmitted in step S713, includes a message indicating requesting an approval of FAX transmission, the destination information input in step S703, and the image data generated in step S712. At this time, if the reply of a message is successful based on the message reply request to the chat server 400, the CPU 201 receives information indicating the success of the message reply request, which is transmitted from the chat server 400.

In step S1105, the CPU 201 controls the communication unit 208 to transmit, to the chat server 400, a message post request issuing an instruction for posting a message for requesting approval to the post destination accepted in step S709. The message post request includes a message indicating requesting an approval of FAX transmission, the destination information input in step S703, and the image data generated in step S712. At this time, if the posting of a message is successful, the CPU 201 receives information indicating the success of the message posting and the thread ID, which are transmitted from the chat server 400.

In step S1104, the CPU 201 determines whether the message reply or message posting from the chat server 400 is successful with respect to the message reply request transmitted in step S1103 or the message post request transmitted in step S1105. Specifically, in a case where a status code included in a response in HTTP communication is a status indicating success or in a case where the CPU 201 has received the thread ID, the CPU 201 determines that the message reply or message posting is successful. On the other hand, in a case where the received status code is an error or in a case where a parameter indicating that the message reply or message posting is failed is included in body information included in the response, the CPU 201 determines that the message reply or message posting is failed. If it is determined that the message reply or message posting is successful (YES in step S1104), the CPU 201 advances the processing to step S1107, and if not so (NO in step S1104), the CPU 201 advances the processing to step S1106.

In step S1106, the CPU 201 causes the facsimile screen 803 to be displayed on the operation unit 205, causes information indicating that the approval request message reply or message posting has not been able to be performed, and then returns the processing to step S1101.

In step S1107, the CPU 201 controls the communication unit 208 to transmit, to the chat server 400, information indicating requesting a message posted to the thread to which posting has been performed in HTTP communication, with use of the thread ID received in step S714. Furthermore, the CPU 201 can transmit, to the chat server 400, information indicating requesting only a message which the user account of the approver has posted from among messages posted to the chat room in HTTP communication, with use of the token information received in step S706. At this time, according to a request from the CPU 201 of the MFP 200, the CPU 401 of the chat server 400 controls the communication unit 405 to transmit the applicable message to the MFP 200. The MFP 200 receives the transmitted message.

In step S1108, the CPU 201 determines whether a keyword related to approval or disapproval of FAX transmission is included in the message received in step S1107. The keyword related to approval is, for example, a character string such as “I approve.”, “No problem.”, or “OK!”, the keyword related to disapproval is, for example, a character string such as “I disapprove.”, “There is a problem.”, or “NG!”, and the keyword is preliminarily set by the user. These keywords related to approval or disapproval are stored in, for example, the storage 204 of the MFP 200. Based on the keywords set by the user, the CPU 201 determines whether a keyword related to approval or disapproval of FAX transmission is included in the message received in step S1107.

Furthermore, a configuration in which, when posting a message including a keyword related to approval or disapproval, the approver is able to designate a FAX job targeted for approval or disapproval by appending, to the message, an identifier for identifying a FAX job, such as a job ID of the FAX job can also be employed. If it is determined that a keyword related to approval or disapproval is included in the message (YES in step S1108), the CPU 201 advances the processing to step S1109, and, if not so (NO in step S1108), the CPU 201 returns the processing to step S1107.

In step S1109, the CPU 201 determines whether a keyword related to approval is included in the message received in step S1107. With regard to this determination, as with step S1108, based on the keywords set by the user, the CPU 201 determines whether a keyword related to approval of FAX transmission is included in the message. Here, in a case where it is determined in step S1108, which is a preceding step, that a keyword related to approval or disapproval is included in the message and no keyword related to approval is included in the message, it is apparent that a keyword related to disapproval is included in the message. Thus, in a case where a keyword related to disapproval is included in the message, in the present step, the CPU 201 determines that no keyword related to approval is included in the message. If it is determined that a keyword related to approval is included in the message (YES in step S1109), the CPU 201 advances the processing to step S1110, and, if it is determined that no keyword related to approval is included in the message (NO in step S1109), the CPU 201 advances the processing to step S1112.

In step S1112, the CPU 201 cancels FAX transmission and deletes a FAX job.

In step S1110, the CPU 201 controls the FAX communication unit 209 to perform FAX transmission of image data generated by reading an original in step S712 to the facsimile apparatus 210 corresponding to the telephone number input by the user in step S703 via the public line network 110.

In step S1111, the CPU 201 causes a FAX transmission result to be displayed on the operation unit 205. At this time, the CPU 201 transmits, to the chat server 400, a message post request issuing an instruction for posting a message related to a FAX transmission result obtained in step S1110 or step $1112.

The content of the message to be posted includes, for example, “FAX transmission is successful.” or “FAX transmission is failed.”.

FIGS. 8A and 8B are diagrams illustrating an example of a screen transition of screens each of which is displayed on the operation unit 205 when the user selects an approver for FAX transmission.

The home screen 801 is a general screen used for the user to select a function to be executed by the MFP 200, and is an example of a screen which is displayed on the operation unit 205 in response to the MFP 200 being powered on. In response to the facsimile button 802, which is displayed in the home screen 801, being selected, the facsimile screen 803 is then displayed on the operation unit 205.

The facsimile screen 803 is a screen used for the user to, when transmitting FAX, input a destination of FAX or call up a screen for performing various settings described below.

In the destination display field 804, destination information, such as a telephone number input as a destination of FAX or a registered name currently registered with an address book, is displayed. Moreover, in a number-of-destinations field 808, the number of destinations which have been set is displayed.

In response to a numeric keypad button 805 being selected, the numeric keypad 807 for inputting a telephone number is displayed. The user is able to set a destination by inputting a telephone number corresponding to the facsimile apparatus 210 serving as a transmission destination of FAX with use of the displayed numeric keypad (software keys) 807.

In response to a transmission setting button 806 being selected, the screen transitions, so that a transmission setting screen 819 is displayed on the operation unit 205. In the transmission setting screen 819, for example, the resolution or density of image data to be FAX-transmitted and the double-sided scanning settings for an original are settable.

In response to the address book button 809 being selected, telephone numbers currently recorded with an address book in the MFP 200 are displayed in a selectable manner. The user is able to set a destination of FAX transmission by selecting a displayed telephone number.

In response to the approver setting button 810 being selected, the screen transitions, so that the approver setting screen 812 is displayed on the operation unit 205. In the approver setting screen 812, the user list 814 is displayed.

The user list 814 is displayed based on user information which the MFP 200 has received from the chat server 400. For example, in a case where a user UserA logs in to the chat server 400 and, in the approver group field 911, a condition of narrowing the approver down to only the boss is designated, user IDs which are currently registered with the chat server 400 as the boss of the user UserA is displayed in the user list 814. Here, UserX and UserY represent user accounts of the bosses of the user UserA. In the approver setting screen 812, the user is able to select a user serving as an approver for FAX transmission from within the displayed user list 814. In a list item for the user who is currently set as an approver, for example, a check mark indicating that effect is displayed, so that the user who is currently selected is displayed in a discriminable manner. If the user who is currently set as an approver is selected again, such a user is excluded from an approver, and the check mark indicating that the user is an approver is hidden.

Furthermore, on this occasion, a mark other than the check mark can be displayed, and the user who is currently selected can be made discriminable by, for example, changing the color of a list item of the selected user. In a number-of-approvers field 816, the number of users who are currently selected as approvers is displayed. In response to the back button 813 being selected, the screen transitions, so that the facsimile screen 803 is displayed on the operation unit 205. Furthermore, at the time of this screen transition, the selection of an approver at the time point of the back button 813 being selected is retained. Furthermore, a configuration in which, when the back button 813 has been selected, options are displayed together with a message such as “Do you want to retain the selection?” and the user can select not retaining the selection of an approver can also be employed.

When the start button 811 has been selected, the CPU 201 of the MFP 200 starts scanning of an original and transmits, to the chat server 400, the generated (acquired) image data and destination information displayed in the destination display field 804. Furthermore, even if the start button 811 is selected (pressed) in any one of the facsimile screen 803, the transmission setting screen 819, and the approver setting screen 812, the similar processing operation is performed. Furthermore, a configuration in which, unless at least one approver has been selected, the start button 811 is unable to be pressed can be employed, or a configuration in which the user is able to select the start button 811 without selecting an approver can also be employed. In a case where the user has pressed the start button without selecting an approver, FAX transmission can be immediately performed without an approve request being transmitted to the chat server 400, or an error display can be performed.

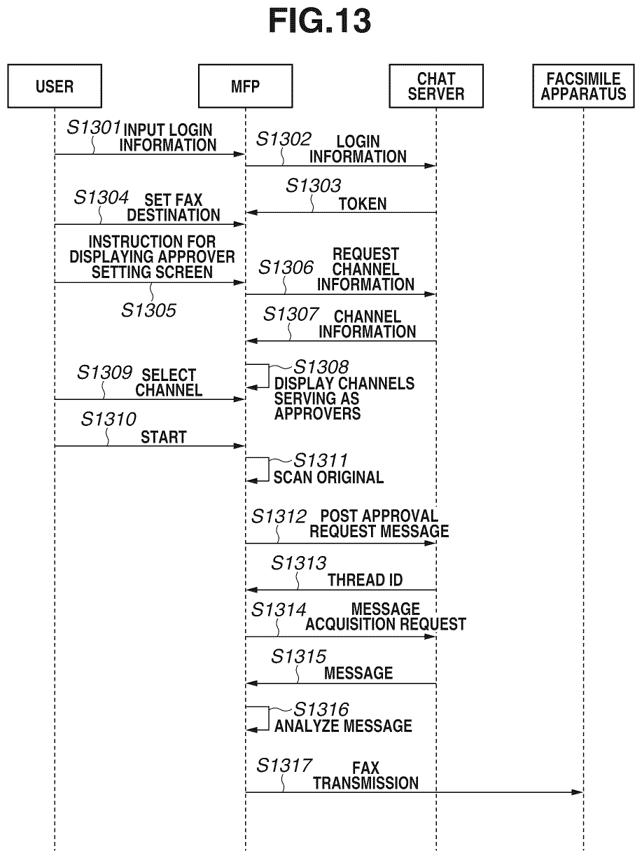

Furthermore, as described below with reference to FIG. 13, a channel can be selected as an approval request destination and an approval request can be posted to the channel. In this case, the user list 814 is displayed based on channel information which the MFP 200 has received from the chat server 400. For example, in the user list 814, channels in which the user participates are displayed as, for example, ChA and ChB. Moreover, in the number-of-approvers field 816, the number of channels which are currently selected as approvers is displayed.

FIG. 9 is a diagram illustrating an example of a button setting screen for performing settings of default values of a FAX job, which is executed with the facsimile button 802. The button setting screen becomes usable by accessing a button setting page which the MFP 200 provides from a browser 901. Furthermore, a configuration in which, in response to a user who has the authority of performing button setting logging in to the MFP 200, the CPU 201 causes the button setting screen to be displayed on the operation unit 205, so that the user becomes able to perform button setting, can also be employed.

In a logged-in user field 902, a user ID of the user who is logged in to the MFP 200 to perform button setting from the browser is displayed. In the case of performing button setting, a user who has an administrator authority of the MFP 200 or a general user who has the authority of performing button setting logs in to the MFP 200.

In response to a logout button 903 being selected, a processing operation in which the user who is logged in to the MFP 200 logs out from the MFP 200 is performed, so that a screen indicating that the user has logged out is displayed in the browser 901.

In an approval setting function field 906, the user is able to select whether to enable or disable the function of performing an approval request for FAX transmission with use of chat. For example, in a case where the user has set the approval setting function to “enable”, unless the user sets at least one approver in the approver setting screen 812, the user becomes unable to select the start button 811. On the other hand, in a case where the user has set the approval setting function to “disable”, a configuration in which the user becomes able to select the start button 811 without setting any approver or a configuration in which the approver setting button 810 is hidden and the user becomes able to select the start button 811 without setting any approver can be employed. Furthermore, such a function is an example of setting acceptance for accepting, from the user, the setting as to whether to perform an approval request.

In a cooperative service selection field 907, the user is able to select a chat service in which the MFP 200 performs a user information request and a message posting for an approval request for FAX transmission. In the cooperative service selection field 907, a list of chat services associated with acquisition processing for user information and message posting processing which are performed by the MFP 200, and the user is able to perform selectin from within the list of chat services to post an approval request to a desired chat service.

In a login ID field 908 and a login password field 909, the user is able to input a login ID and password to log in to the chat service selected in the cooperative service selection field 907.

In a text field 910, the user is able to set a template message when posting an approval request to the chat service. In the approver group field 911, the user sets an extraction condition for users to be displayed in the approver setting screen 812. For example, in a case where “boss” has been set in the approver group field 911, only users who are bosses of the FAX transmission user, extracted from the user information acquired from the chat server 400, are displayed in the user list 814 displayed in the approver setting screen 812. Besides, the user can perform settings in the approver group field 911, including the setting of extracting only users belonging to a designated affiliated department and the setting of extracting only users belonging to a designated channel. Furthermore, only in a case where the approval setting function field 906 set before FAX transmission is set to “enable”, the respective fields 907 to 911 for the transmission settings for an approval request are displayed in such a way as to enable performing settings.

A resolution field 912, a density field 913, and a double-sided original field 914 are provided for transmission settings of facsimile, and allow values which are displayed in the transmission setting screen 819 for the first time to be set therein. Furthermore, besides these, general parameters which are used for FAX transmission can be made settable, and the set parameters are similarly reflected as values which are displayed in the transmission setting screen 819 for the first time.

In response to an OK button 904 being selected, the setting values which have been set in the present button setting screen at that point of time are then stored in the storage 204. In response to a cancel button 905 being selected, the settings which have been set in the present button setting screen are cleared to end the button settings.

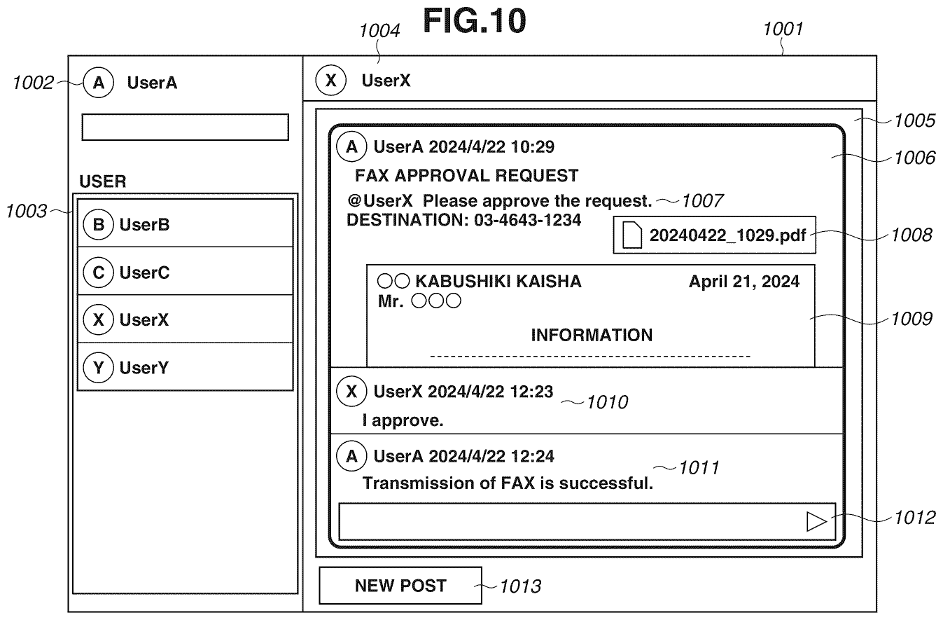

FIG. 10 is a diagram illustrating an example of a screen in which, in response to the chat server 400 receiving an approval request transmitted from the MFP 200, the posted message is being displayed by a chat application which runs on the terminal device 300. Thus, FIG. 10 is a diagram illustrating an example of a graphical user interface (GUI) of the chat application in a case where an approval request for FAX transmission has been posted to the approver.

A chat application screen 1001 is displayed on the operation unit 305 of the terminal device 300. In a logged-in user ID field 1002, a user ID of the user who has logged in to the chat server 400 is displayed. In a user selection field 1003, user IDs of users who are able to exchange messages or files by chat are displayed in a list form, and the user is able to select a desired user and start exchange of messages or files by chat with the selected user. Specifically, a chat room for the user and the user selected by the user is displayed, and the user posts messages or files to the chat room, thus being able to perform exchange with the other party user by chat.

In a destination user display field 1004, the user ID selected in the user selection field 1003 is displayed. Thus, this indicates that a chat room for the user and the other user is being displayed. In a chat field 1005, exchange performed by chat between the user (UserX) displayed in the destination user display field 1004 and the user (UserA) who is logged in to the chat application is displayed.

A thread 1006 is a thread obtained by lumping exchange of messages about a given specific topic together, and, while, in the first exemplary embodiment, a new thread is assumed to be created with respect to one FAX job, threads can be lumped together with respect to each FAX transmission destination.

The thread 1006 illustrated in FIG. 10 is an example of exchange for approval in a case where the user UserX has been selected as an approver. To the thread 1006, a text 1007 of the approval request posted from the MFP 200, a preview 1009 of image data, and a link 1008 to an image data file have been posted. Moreover, exchange of messages including a reply message 1010 by the approver (UserX) as a reply to the approval request message and a message 1011 of FAX transmission result is being performed in the thread 1006. Furthermore, the link to an image data file represents the location of a file (image data).

The text 1007 is a cooperative message which has been set by the user in the text field 910 of the button setting screen. In the text 1007, “@” indicates that mention is being made of the user written following this mark. This mark being attached provides an advantageous effect that the approver becomes better able to recognize a message, for example, even in a case where the approver partially turns off a notification of the chat service, the message becomes likely to reach the approver. In the first exemplary embodiment, a mention made of the user selected by the user in the approver setting screen 812 is automatically incorporated into a text. Furthermore, mention being made is not necessary.

The link 1008 to an image data file is a link to an image data file that is based on image data acquired by scan performed in response to the start button 811 being selected. The preview 1009 of image data is a preview image that is based on image data acquired by scan performed in response to the start button 811 being selected.

The reply message 1010 is a message which is posted to the chat room by the approver user sending a reply to the approval request message, and is a message indicating approval, such as, in addition to “I approve.”, “OK!” or “No problem.”. Furthermore, in a case where there is a problem with the FAX content, a message indicating disapproval, such as “I disapprove.”, “NG!”, or “There is a problem.”, is posted as the reply message 1010 by the approver.

The message 1011 of FAX transmission result is a message indicating a result of FAX transmission which is performed according to the content of the reply message 1010, and, in a case where FAX transmission is successful, a message such as “Transmission of FAX is successful.” is posted and, in a case where FAX transmission is failed, a message such as “Transmission of FAX is failed.” is posted.

A message entry field 1012 is an entry field into which, at the time of transmitting a message to the thread 1006, to enter the message. A new post button 1013 is a button which is selected in the case of creating a new thread.

Furthermore, instead of a user ID, a display name corresponding to the user ID, such as a nickname which the user has registered, can be displayed.

In the above-described first exemplary embodiment, the method of posting a message for approval request to a chat room of the approver has been described. In a second exemplary embodiment of the present disclosure, the method of posting a message for approval request to a channel is described.

FIG. 13 is a sequence diagram illustrating an example of processing in which the user selects, as a transmission destination for an approval request, a channel used for performing exchange of messages related to a specific topic and posts an approval request for FAX transmission to the channel.

In step S1301, the user inputs, to the operation unit 205 of the MFP 200, a user ID and a password for logging in to a chat service which the chat server 400 provides, and the CPU 201 accepts such inputs. In an information acquisition request which is made to the chat server 400 in the subsequent steps, token information which has been acquired by the CPU 201 controlling the communication unit 208 to transmit the user ID and the password input in step S1301 to the chat server 400 is assumed to be used. Furthermore, instead of the token information, the user ID and the password input by the user in step S1301 can be directly used for authentication. Moreover, login information for the MFP 200 and login information for a chat service which the chat server 400 provides can be preliminarily stored in the storage 204. In that case, the login information preliminarily stored in the MFP 200 is used as login information to be input by the user in step S1301, and, in that case, without the user inputting login information for the chat server 400, the processing proceeds to step S1302.

In step S1302, the CPU 201 of the MFP 200 controls the communication unit 208 to transmit the login information and the password input in step S1301 to the chat server 400, and the chat server 400 receives the transmitted login information and password.

In step S1303, the CPU 401 of the chat server 400 performs authentication based on the login information and password received in step S1302. In response to the authentication being successful, the CPU 401 issues token information, which becomes required for, for example, an information acquisition request to the chat server 400, and controls the communication unit 405 to transmit the token information to the MFP 200. The MFP 200 receives the transmitted token information. In step S1304, the user inputs, to the operation unit 205 of the MFP 200, a telephone number of the facsimile apparatus 210 to be designated as a FAX transmission destination, and the CPU 201 of the MFP 200 accepts the input telephone number.

In step S1305, in response to the user pressing the approver setting button 810 to cause the approver setting screen 812 for setting a FAX approver to be displayed, the CPU 201 of the MFP 200 accepts this pressing as an instruction for displaying the approver setting screen 812.

In step S1306, the CPU 201 of the MFP 200 controls the communication unit 208 to transmit, to the chat server 400, an instruction for requesting channel information by HTTP communication, and the chat server 400 receives the transmitted instruction. Specifically, the CPU 201 causes the communication unit 208 to transmit, to the chat server 400, an instruction for requesting information about a channel in which the user participates indicated by the token information acquired in step S1303.

In step S1307, the CPU 401 of the chat server 400 checks whether the logged-in user is a user who has been allowed to access the chat service, based on the token information attached to the channel information request received in step S1306. In a case where the logged-in user is a user who has been allowed to access the chat service, according to the channel information request, the CPU 401 of the chat server 400 searches for channels in which the user participates indicated by the token information. The CPU 401 controls the communication unit 405 to transmit, to the MFP 200, channel information about the channels found by searching as response information in HTTP communication. The MFP 200 receives the transmitted channel information.

In step S1308, based on the channel information received in step S1307, the CPU 201 of the MFP 200 causes the approver setting screen 812 to be displayed on the operation unit 205, and thus waits for the user to perform an operation thereon.

In step S1309, the user selects a channel serving as a post destination in the approver setting screen 812 displayed on the operation unit 205, and the CPU 201 of the MFP 200 then receives selection of the channel and thus determines a channel to which to transmit an approval request. Usually, the channel which the user selects is a channel in which, in addition to the user who performs selection, the approver also participates.

In step S1310, the user presses the start button 811, and the CPU 201 of the MFP 200 then accepts a start instruction for FAX transmission via the operation unit 205.

In step S1311, the CPU 201 of the MFP 200 controls the reading unit 207 to scan an original, thus generating image data. Furthermore, the user is assumed to, before execution of step S1311, have completed placing of an original on the reading unit 207 and general FAX settings which are used for FAX transmission. The general FAX settings include, for example, destination setting, density setting, image quality mode setting, and scan mode setting.

In step S1312, the CPU 201 of the MFP 200 controls the communication unit 208 to transmit, to the chat server 400, information for issuing an instruction for posting an approval request message to the channel selected by the user in step S1309. The approval request message includes a message indicating requesting an approval of FAX transmission, a telephone number of the facsimile apparatus 210 serving as a transmission destination input in step S1304, and image data generated in step S1311. Furthermore, the approval request message does not necessarily need to include image data generated in step S1311.

In step S1313, the CPU 401 of the chat server 400 posts the message received in step S1312 to a channel of the chat service. Furthermore, the channel to which the message is posted is a channel which the user has selected in step S1309. The CPU 401 controls the communication unit 405 to transmit, to the MFP 200, a thread ID of the thread to which the message has been posted, and the MFP 200 receives the transmitted thread ID.

In step S1314, the CPU 201 of the MFP 200 controls the communication unit 208 to check an approval status of the approval request posted in step S1312. Specifically, the CPU 201 controls the communication unit 208 to transmit, to the chat server 400, a message acquisition request issuing an instruction for acquiring a message posted to the thread corresponding to the thread ID received in step S1313 and the thread ID. The chat server 400 receives the transmitted message acquisition request and thread ID. Furthermore, this processing operation can be performed by the CPU 201 a plurality of times. For example, this processing operation can be repeated until a message is posted to a thread to which the CPU 401 has performed posting in step S1312. Besides, a processing operation in the present step can be performed each time a predetermined time elapses, or can be performed a predetermined number of times.

In step S1315, the CPU 401 of the chat server 400 checks whether there is a message (reaction) which has been posted to a thread indicated by the thread ID attached to the message acquisition request received in step S1314. In a case where there is a message which has been posted to a thread indicated by the received thread ID, the CPU 401 controls the communication unit 405 to transmit, to the MFP 200, a message posted to the thread indicated by the received thread ID. The MFP 200 receives the transmitted message.

In step S1316, the CPU 201 of the MFP 200 analyzes the message received in step S1315 and determines whether the received message is a message indicating approving FAX transmission. The determination as to whether the received message is a message indicating approving FAX transmission is described below with reference to FIGS. 7A and 7B.

In step S1317, the CPU 201 of the MFP 200 controls the FAX communication unit 209 to perform FAX transmission of the image data obtained by scanning in step S1311 to the facsimile apparatus 210 corresponding to the telephone number which the user has input in step S1304. Furthermore, this processing operation is performed in a case where it is determined that the message received in step S1316 is a message indicating approving FAX transmission, and is not performed in a case where it is determined that the received message is not a message indicating approving FAX transmission.

FIGS. 7A and 7B in the case of the second exemplary embodiment are flowcharts illustrating an example of processing for posting an approval request for FAX transmission to a channel when the MFP 200 performs FAX transmission.

The processing in the present flowchart is implemented by the CPU 201 of the MFP 200 reading out a program stored in the ROM 202 onto the RAM 203 and executing the program. Moreover, the processing in the flowcharts of FIGS. 7A and 7B is started in response to the MFP 200 being powered on.

Furthermore, unlike the first exemplary embodiment, in which a message for approval request is posted to a chat room of the approver, in the second exemplary embodiment, a message for approval request is posted to a channel. In the following description, portions different from those in the first exemplary embodiment are described.

Steps S701 to S706 and step S720 in the second exemplary embodiment are similar to those in the first exemplary embodiment and are, therefore, omitted from description here.

In step S707, the CPU 201 controls the communication unit 208 to transmit, to the chat server 400, information indicating requesting channel information in HTTP communication with use of the token information received in step S705. At this time, according to the request for channel information, the chat server 400 searches for a channel in which the user participates indicated by the token information, and transmits channel information about the channel found by searching to the MFP 200. The MFP 200 receives the transmitted channel information. At this time, the CPU 401 of the chat server 400 performs searching based on the user information list 500.

Furthermore, in a case where a channel is currently designated by a user, the chat server 400 transmits, to the MFP 200, channel information corresponding to the designated channel. Accordingly, in the present step, the MFP 200 receives the channel information transmitted from the chat server 400. Furthermore, the MFP 200 can be configured to receive both the user information and the channel information.

In step S708, the CPU 201 determines whether the channel information has been received from the chat server 400 with respect to the channel information request transmitted in step S707. Specifically, in a case where the CPU 201 has received channel information from the chat server 400, the CPU 201 determines that the channel information has been received.

On the other hand, in a case where a status code included in a response in HTTP communication is an error or in a case where a parameter indicating that channel information is unable to be acquired is included in body information included in the response, the CPU 201 determines that the channel information has not been received. If it is determined that the channel information has been received (YES in step S708), the CPU 201 advances the processing to step S709, and, if not so (NO in step S708), the CPU 201 advances the processing to step S721.

In step S721, the CPU 201 causes the approver setting screen 812 to be displayed on the operation unit 205 and causes information indicating that the channel information has not been received to be displayed in the approver setting screen 812.

At this time, options for a channel are not displayed in the approver setting screen 812.

Step S722 in the second exemplary embodiment is similar to that in the first exemplary embodiment and is, therefore, omitted from description here.

In step S709, the CPU 201 causes the user list 814, which is based on the channel information received from the chat server 400, to be displayed in the approver setting screen 812 displayed on the operation unit 205, waits for the user's selection, and, in a case where a selection operation has been performed, detects the selection operation and accepts the selection. Thus, the CPU 201 accepts a post destination to which to post an approval request message.

In step S710, the CPU 201 determines whether a channel serving as a post destination of the approval request message has been selected by the user in the approver setting screen 812. If it is determined that the channel has been selected (YES in step S710), the CPU 201 advances the processing to step S711, and, if not so (NO in step S710), the CPU 201 waits until the channel is selected.

The detection of selection is performed based on which of channels included in the user list 814 displayed in the approver setting screen 812 has been selected. Furthermore, in the case of a screen configuration in which a confirm button is displayed in the screen of the operation unit 205, if the confirm button is pressed in a state in which a channel included in the user list 814 has been selected, a similar transition in steps is also performed.

Steps S711 and S712 in the second exemplary embodiment are similar to those in the first exemplary embodiment and are, therefore, omitted from description here.

In step S713, the CPU 201 transmits, to the chat server 400, a message post request to issue an instruction for posting an approval request message to the channel selected by the user in step S710. The approval request message includes a message indicating requesting an approval of FAX transmission, the destination information input in step S703, and the image data generated in step S712. Furthermore, the approval request message does not necessarily need to include image data generated in step S712. At this time, if the chat server 400 succeeds in posting the message, the CPU 201 receives information indicating a result of posting of the message transmitted from the chat server 400. Specifically, if the chat server 400 succeeds in posting the message, the CPU 201 receives information indicating a success of posting of the message.

Furthermore, while, in the present processing operation, one thread is assumed to be created with respect to one FAX job, in a case where a thread to which posting related to approval of FAX transmission to the same destination as the destination input in step S703 has been performed already exists, a message can also be posted additionally to the already-existing thread.

Step S714 in the second exemplary embodiment is similar to that in the first exemplary embodiment and is, therefore, omitted from description here.

In step S723, the CPU 201 causes the facsimile screen 803 to be displayed on the operation unit 205, causes information indicating that an approval request message has not been able to be posted to the designated channel to be displayed, and then returns the processing to step S713.

Processing operations in step S715 and subsequent steps in the second exemplary embodiment are similar to those in the first exemplary embodiment and are, therefore, omitted from description here.

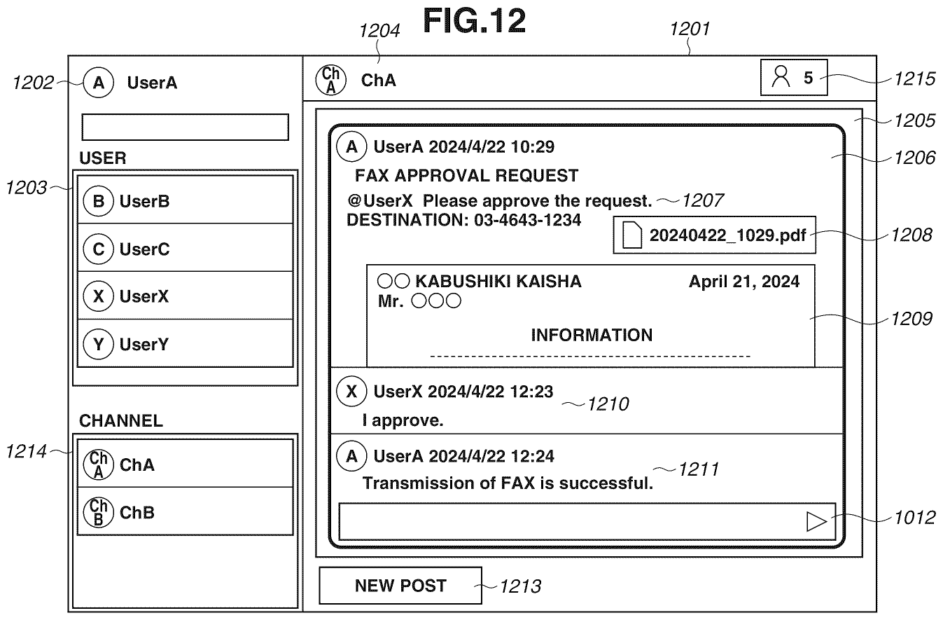

FIG. 12 is a diagram illustrating an example of a screen in which, in response to the chat server 400 receiving an approval request transmitted from the MFP 200, a message posted to not a user but a channel is being displayed by a chat application which runs on the terminal device 300.

A chat application screen 1201 is displayed on the operation unit 305 of the terminal device 300. In a logged-in user ID field 1202, a user ID of the user who has logged in to the chat server 400 is displayed. In a user selection field 1203, user IDs of users who are able to exchange messages or files by chat are displayed in a list form, and the user is able to select a desired user and start exchange of messages or files by chat with the selected user. Specifically, a chat room for the user and the user selected by the user is displayed, and the user posts messages or files to the chat room, thus being able to perform exchange with the other party user by chat.

In a channel selection field 1214, channel names of channels which are able to exchange messages or files by chat are displayed in a list form. Exchange of messages or files by chat is started between members participating in a channel selected by the user selecting a desired channel. Specifically, a chat room for the channel selected by the user is displayed, and the user posts messages or files to the chat room, thus being able to perform exchange with the other user participating in the channel by chat.

In a destination channel display field 1204, a channel name selected in the channel selection field 1214 is displayed. Thus, this indicates that a chat room for the selected channel is being displayed.

In a participating member field 1215, the number of users participating in the channel which is being displayed in the destination channel display field 1204 is displayed. In a chat field 1205, exchange which has been performed by chat in the channel (ChA) which is being displayed in the destination channel display field 1204 is displayed.

A thread 1206 is a thread obtained by lumping exchange of messages about a given specific topic together, and, while, in the second exemplary embodiment, a new thread is assumed to be created with respect to one FAX job, threads can be lumped together with respect to each FAX transmission destination.

The thread 1206 illustrated in FIG. 12 is an example of exchange for approval which is being performed in the channel ChA. To the thread 1206, a text 1207 of the approval request posted from the MFP 200, a preview 1209 of image data, and a link 1208 to an image data file have been posted. Moreover, exchange of messages including a reply message 1210 by the member (UserX) participating in the channel ChA as a reply to the approval request message and a message 1211 of FAX transmission result is being performed in the thread 1206.

The text 1207 is a cooperative message which has been set by the user in the text field 910 of the button setting screen. In the text 1207, “@” indicates that mention is being made of the user written following this mark. This mark being attached provides an advantageous effect that the approver becomes better able to recognize a message, for example, even in a case where the approver partially turns off a notification of the chat service, the message becomes likely to reach the approver. In the second exemplary embodiment, a mention made of all of the users belonging to the channel selected by the user in the approver setting screen 812 is automatically incorporated into a text. Furthermore, mention being made is not necessary. Moreover, a configuration in which the user is able to designate a channel and a specific user participating in the channel in the approver setting screen 812 can be employed, and a mention directed to the specific user individual can be made.

The link 1208 to an image data file is a link to an image data file that is based on image data acquired by scan performed in response to the start button 811 being selected. The preview 1209 of image data is a preview image that is based on image data acquired by scan performed in response to the start button 811 being selected.

The reply message 1210 is a message which is posted to the chat room by the approver user sending a reply to the approval request message, and is a message indicating approval, such as, in addition to “I approve.”, “OK!” or “No problem.”. Furthermore, in a case where there is a problem with the FAX content, a message indicating disapproval, such as “I disapprove.”, “NG!”, or “There is a problem.”, is posted as the reply message 1210 by the approver.

The message 1211 of FAX transmission result is a message indicating a result of FAX transmission which is performed according to the content of the reply message 1210, and, in a case where FAX transmission is successful, a message such as “Transmission of FAX is successful.” is posted and, in a case where FAX transmission is failed, a message such as “Transmission of FAX is failed.” is posted.

A message entry field 1212 is an entry field into which, at the time of transmitting a message to the thread 1206, to enter the message. A new post button 1213 is a button which is selected in the case of creating a new thread.

As described above, according to the above-described configuration, it becomes possible to reduce the trouble of performing FAX transmission based on an approval of FAX transmission.

Furthermore, a configuration in which a message by the approver described in the first and second exemplary embodiments (replay message 1210) is substituted with, for example, a specific reaction function can be employed. For example, a configuration in which a thumbs-up reaction or an OK stamp is preliminarily set as with a keyword related to approval and, in a case where such a reaction has been performed with respect to an approval request message, it is determined that approval has been obtained and FAX transmission is performed can also be employed. Such a reaction is a symbol which gives an impression of approval, and can be, in addition to a thumbs-up symbol or an OK stamp, a circular symbol, a smiling face symbol, or a green symbol.

Moreover, an approval request message can have an object format, such as a button, and a configuration in which the CPU 201 posts buttons displayed as “approve” and “disapprove”, the approver designates one of such objects, the approval or disapproval is determined based on such designation, and, then, FAX transmission is performed accordingly can also be employed.

Furthermore, while, in the above-described first and second exemplary embodiments, the method of acquiring user information about a specific user and the method of acquiring channel information about a channel to which the user belongs have been described with reference to FIG. 6 and FIG. 13, respectively, a configuration which acquires both the user information and the channel information can also be employed. Such a configuration causes users and channels to be displayed in the user list 814 based on the acquired information, and thus enables increasing targets from which the user is able to select as a post destination of the approval request message, thus facilitating using an optional post destination.

Furthermore, while, in the above-described first and second exemplary embodiments, an example in which the approval request message is posted to one talk room (chat room) has been described, a configuration in which the user is allowed to select a plurality of post destinations and, in response to a plurality of post destinations being selected, the approval request message is posted to the chat room can also be employed. In this case, a configuration in which whether to perform FAX transmission is determined by using, as a determination material, the approval or disapproval by an approver who has sent the earliest reply can be employed, or a configuration in which whether to perform FAX transmission is determined after replies of all of the approver have been received or is determined based on the collected approvals and disapprovals can also be employed. In a case where whether to perform FAX transmission is determined based on the collected approvals and disapprovals, for example, a condition such as the case of having received a majority of replies of approvers is preliminarily determined and, when the condition has been satisfied, in a case where there are a majority of replies indicating approval, it is determined that approval has been obtained.

Furthermore, while, in the above-described first and second exemplary embodiments, an example in which, based on the content of a message received as a reply to the approval request message, it is determined that approval has been obtained and FAX transmission is performed has been described, the first and second exemplary embodiments are not limited to this example. For example, a configuration in which, in a case where there is a reply of some kind to the posted approval request message, without based on the content of the reply, there being a reply is determined as approval and FAX transmission is performed can also be employed.

Furthermore, the method of transmission is not limited to FAX. In addition to FAX, the present disclosure can also be applied to, for example, the case of transmitting image data via e-mail.

The present disclosure can also be implemented by processing for supplying a program for implementing one or more functions of the above-described exemplary embodiments to a system or apparatus via a network or a storage medium and causing one or more processors included in a computer of the system or apparatus to read out and execute the program. Moreover, the present disclosure can also be implemented by a circuit which implements one or more functions of the above-described exemplary embodiments (for example, an application specific integrated circuit (ASIC)).

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-104686 filed Jun. 28, 2024, which is hereby incorporated by reference herein in its entirety.

What is claimed is:

1. An image processing apparatus comprising:
at least one memory storing programs; and
at least one processor that executes the stored programs, which cause the at least one processor to:
perform control to acquire image data,
perform control to receive, from a chat server which provides a chat service which a user who has logged in to the image processing apparatus uses, information corresponding to user information about the user,
perform posting to a post destination of the chat service based on the information, and
perform control to transmit the image data,
wherein the posting includes posting information for seeking approval to transmit the image data, and
wherein the image data is transmitted based on a reaction to the posted information for seeking approval having been received.

2. The image processing apparatus according to claim 1, wherein the image data is transmitted based on the reaction to the posted information for seeking approval being a reaction indicating approval.

3. The image processing apparatus according to claim 2, wherein the reaction indicating approval is a character string registered with the image processing apparatus by the user, and is a character string reply including a character string indicating approval.

4. The image processing apparatus according to claim 2, wherein the reaction indicating approval is a reaction used for using a function included in the chat service, and is a symbol which gives an impression of approval.

5. The image processing apparatus according to claim 4, wherein the symbol which gives an impression of approval is a thumbs-up symbol.

6. The image processing apparatus according to claim 4, wherein the symbol which gives an impression of approval is a symbol including a character string of OK.

7. The image processing apparatus according to claim 1, wherein, in a case where the reaction to the posted information for seeking approval is a reaction indicating disapproval, the image data is not transmitted.

8. The image processing apparatus according to claim 1, wherein the at least one processor further executes the stored programs to:
accept, from the user, designation of a post destination which is based on the received information, which serves as a post destination of the information for seeking approval, and
post the information for seeking approval to the designated post destination.

9. The image processing apparatus according to claim 1, wherein the information for seeking approval is user information corresponding to an approver.

10. The image processing apparatus according to claim 1, wherein the information for seeking approval is channel information about a channel in which the user participates.

11. The image processing apparatus according to claim 1, wherein the information for seeking approval includes a message.

12. The image processing apparatus according to claim 1, wherein the information for seeking approval includes image data.

13. The image processing apparatus according to claim 1, wherein the information for seeking approval includes information indicating a location of the image data.

14. The image processing apparatus according to claim 11, wherein the information for seeking approval further includes an object for reacting to the message.

15. The image processing apparatus according to claim 1, wherein the information for seeking approval includes information about a transmission destination of the image data.

16. The image processing apparatus according to claim 1, wherein the at least one processor further executes the stored programs to:
perform control to accept, from the user, a setting as to whether to make an approval request,
wherein, in a case where a setting not to make an approval request is accepted, the image data is transmitted without performing the posting.

17. A non-transitory computer-readable storage medium for storing a program causing an image processing apparatus to perform a method of transmitting image data, the method comprising:
acquiring the image data;
receiving, from a chat server which provides a chat service which a user who has logged in to the image processing apparatus uses, information corresponding to user information about the user;
performing posting to a post destination of the chat service based on the information; and
transmitting the image data,
wherein the posting includes posting information for seeking approval to transmit the image data, and
wherein transmitting the image data is performed based on a reaction to the posted information for seeking approval having been received.

18. A method of transmitting image data, the method comprising:
acquiring the image data;
receiving, from a chat server which provides a chat service which a user who has logged in to the image processing apparatus uses, information corresponding to user information about the user;
performing posting to a post destination of the chat service based on the information; and
transmitting the image data,
wherein the posting includes posting information for seeking approval to transmit the image data, and
wherein transmitting the image data is performed based on a reaction to the posted information for seeking approval having been received.
